(19) United States
(12) Patent Application Publication
(10) Pub. No.: US 2018/0231039 A1
(43) Pub. Date: Aug. 16, 2018

(54) PIPE CONNECTION ARRANGEMENT AND PIPE CONNECTION OF TWO PIPES

(71) Applicant: TOURATECH AG, Niedereschah (DE)

(72) Inventors: Jochen Schanz, Niedereschach (DE); Herbert Schwarz, Niedereschach (DE)

(21) Appl. No.: 15/514,903

(22) PCT Filed: Sep. 29, 2015
(86) PCT No.: PCT/EP2015/072431

§ 371 Date: Mar. 28, 2017

(30) Foreign Application Priority Data
Sep. 29, 2014 (DE) 102014014435.6

(51) Int. Cl. F16B 7/18; B62J 27/00

(52) U.S. Cl. CPC F16B 7/182; B60R 2021/137; B62J 27/00

(57) ABSTRACT

A tube connection arrangement includes a tube having a cutout configured such that a part-tube portion adjoins a full-tube portion of the tube. An insert has a first portion for being received in the full-tube portion of the tube and has an external circumference adapted to the internal circumference of the full-tube portion, and a second portion for being received in the part-tube portion of the tube. The second portion has a curved contour adapted to the internal contour of the part-tube portion, an opposite abutment side. In the inserted state of the insert, the abutment side of the second portion is directed towards the cutout and through-openings in the part-tube portion and in the second portion of the insert are aligned in order to enable a fastening element to be fed through.

### RELATED APPLICATION

This application corresponds to PCT/EP2015/072431, filed Sep. 29, 2015, which claims the benefit of German Application No. 10 2014014 435-6, filed Sep. 29, 2014, the subject matter of which are incorporated herein by reference in their entirety.

### BACKGROUND OF THE INVENTION

The present invention relates to a tube connection arrangement and to a tube connection of two tubes, in particular for connecting crash bars for motorcycles or snowmobiles to one another or to the body or frame of the vehicle in question.

Various tube connection arrangements are known in the art for fastening crash bars for motorcycles or snowmobiles to one another or to the body or frame of the vehicle in question. In one known tube connection arrangement, there is welded to the end of a full tube a fastening attachment having a first portion, which extends into the full tube, and a second portion, which has a fastening lug extending away from the tube. Such fastening attachments are usually made of metal and formed as solid cast components. They are therefore expensive to manufacture and, moreover, have to be laboriously fastened to the tube by welding, which makes assembly thereof more difficult. One such tube connection arrangement is known for example from EP 2 429 865 B1.

The problem addressed by the invention is therefore that of providing a tube connection arrangement, in particular for crash bars of motorcycles or snowmobiles, which facilitates the connection of a tube to a counter-surface or the connection of two tubes.

### SUMMARY OF THE INVENTION

According to the invention, a tube connection arrangement according to claim 1 or 8 or a tube connection according to claim 7 is provided for this purpose. Further embodiments will becomes apparent, inter alia, from the dependent claims.

According to one embodiment, a tube connection arrangement is provided which comprises a specially shaped tube and an insert adapted thereto. The tube has at least one cutout which is configured such that a part-tube portion adjoins a full-tube portion of the tube, wherein at least one through-opening is formed in the part-tube portion. The insert has a first portion which is suitable for being received in the full-tube portion of the tube and which has an external circumference adapted to the internal circumference of the full-tube portion, and a second portion which is suitable for being received in the part-tube portion of the tube and which has a curved contour, adapted to the internal contour of the part-tube portion, and an opposite abutment side, wherein at least one through-opening is formed in the second portion. In the inserted state of the insert, the abutment side of the second portion is directed towards the cutout of the part-tube and the through-openings in the part-tub(c) portion and in the second portion of the insert are aligned with one another in order to enable a fastening element to be fed through. Such a tube connection arrangement is on the one hand easy to manufacture and makes it easier to assemble one tubs to a second tube or to a flat mounting surface. In particular, the insert need not be laboriously connected to the tube since the position of said insert can be ensured by a fastening element which extends through the through-openings. The insert forms an abutment surface and can prevent any deformation, in particular any spreading, of the part-tube portion as a fastening element is tightened.

The insert preferably has, at a free end of the second portion and/or at the end of the first portion located adjacent to the second portion, an abutment flange for abutment against a front edge of the part-tube portion. As a result, the depth of insertion of the insert into the tube can easily be limited in order to make it easier to position and align the through-openings. The abutment flange and the corresponding front edge have at least one complementary alignment contour for also ensuring alignment in the direction of rotation of the tube.

In one embodiment, at least two through-openings are provided in the part-tube portion and in the second portion of the insert in order to enable a rotationally fixed connection which prevents any rotation about an axis perpendicular to the abutment surface of the insert.

The insert is preferably a plastic cast component, in particular an injection-moulded or die-cast component which can be manufactured at low cost and also has the necessary strength. It is advantageous that the insert, in the installed state, is substantially covered by the full-tube portion and by the part-tube portion and is at least partially protected against mechanical influences.

According to one aspect, the tube connection arrangement further comprises at least one washer component which has a first side, adapted to the external contour of the part-tube portion, and an opposite second side, wherein the washer component has at least one through-opening for a fastening element, and wherein the second side has in the region of the through-opening a flat abutment surface for a fastening element. It is thus possible to ensure a good fastening for example via a screw or a rivet, which may be problematic if the latter act against a curved surface.

In one embodiment of the tube connection arrangement, the cutout for forming the part-tube portion is formed at the end of the tube in such a way that the part-tube portion protrudes beyond the full-tube portion in order to enable an end fastening of the tube in question. To enable a rotationally fixed connection of the tube end, a front end of the full-tube portion and/or of the part-tube portion may have a tooth structure. To transmit tensile forces in the longitudinal direction of the tube, at least one radially directed longitudinal edge of the part-tube portion may have a tooth structure. In this case, the aforementioned tooth structures may describe for example one of the following shapes: saw-tooth, rectangle, triangle and wave.

In one embodiment of the tube connection arrangement, the cutout for forming the part-tube portion is located between two full-tube portions in order to enable a connection at a distance from the end of a tube. In this embodiment, the insert has a third portion which is suitable for being received in the full-tube portion of the tube and which has an external contour adapted to the internal circumference of the full-tube portion, and wherein the second portion of the insert is located between the first and the third portion.

The abutment side of the insert may be flat or else may have a tooth structure. A flat abutment side enables particularly easy assembly in different positions, while a tooth structure generally leads to a defined positioning and also enables a better force transmission via the inserts.

The part-tube portion preferably forms substantially a half-tube portion, the term “substantially” being intended to encompass a maximum angle deviation of 10°, preferably 5°.

In the tube connection of two tubes, a tube connection arrangement of the above type is provided for each tube, wherein the part-tube portions of the tubes with inserted inserts are arranged in an overlapping manner in such a way that the abutment sides of the second portions of the inserts make contact with one another, and wherein at least one fastening element is provided which extends through the through-openings in the two part-tube portions and in the inserts in order to fasten the tubes to one another. Such a tube connection can be produced easily and at low cost.

In such a tube connection, the tube connection arrangements for each of the tubes may each have a tooth structure, wherein the tooth structures of the tube connection arrangements are complementary to one another in order to be able to transmit tensile and/or rotational forces between the tube elements. The tooth structures may be formed in at least one of the following: a front end of the full-tube portion, a front end of the part-tube portion, a radially directed longitudinal edge of the part-tube portion and the abutment side of the insert.

An alternative tube connection arrangement for two tubes has for each of the tubes, on at least one fastening end, a cutout which is configured such that, adjoining a full-tube portion of the respective tube, a part-tube portion is formed which can be arranged in a manner overlapping the part-tube portion of the other tube, wherein at least one through-opening is formed in each part-tube portion. The alternative tube connection arrangement further comprises an insert having an external circumference adapted to the internal circumference of the full-tube portions and a length which is longer than that of a respective part-tube portion. In this case, the length is so long that the opposite ends of the insert can be received in both full-tube portions of the tubes when the part-tube portions of the tubes are arranged in an overlapping manner. The insert also has at least one through-opening which can be aligned with the through-openings in the part-tube portions when the opposite ends of the insert are received in the full-tube portions of the tubes, in order to enable a fastening element to be fed through the part-tube portions and the insert. Such a tube connection arrangement can also easily be produced simply by plugging the tubes in a particular orientation onto the insert and then fastening by way of suitable fastening elements. In doing so, the part-tube portions overlap one another so that tensile forces acting between the tubes can be conducted directly into the tubes.

The insert preferably has, between its opposite ends, at least one abutment flange for abutment against a front edge of a part-tube portion in order to limit the depth of insertion of the insert. The abutment flange and the front edge preferably have at least one complementary alignment contour in order to be able to perform an alignment in the circumferential direction of the tube.

### BRIEF DESCRIPTION OF THE DRAWINGS

The invention will be explained in greater detail below with reference to the drawings, in which:

FIG. 1 shows a perspective arrangement of one embodiment of a tube connection of two tubes;

FIG. 2 shows a schematic side view of the tube connection according to FIG. 1 in the connected state;

FIG. 3 shows a sectional view along the line III-III in FIG. 2;

FIG. 4 shows a schematic perspective view from above of the tube connection according to FIG. 2;

FIG. 5 shows a schematic side view of an insert of a tube connection arrangement;

FIG. 6 shows a schematic perspective view from above of the insert according to FIG. 5;

FIG. 7 shows a schematic perspective view from below of the insert according to FIG. 5;

FIG. 8 shows a plan view and a side view of a washer element;

FIG. 9 shows a schematic side view of an alternative insert for a tube connection for two tubes;

FIG. 10 shows different views of a tube connection arrangement according to the invention for fastening to a non-tubular counter-surface, wherein FIG. 10a shows a side view, FIG. 10b shows a sectional view along the line b-b in FIG. 10a, FIG. 10c shows a plan view, and FIG. 10d shows a perspective exploded view;

FIGS. 11 to 18 show different views of tube connection arrangements according to the Invention for two tubes, wherein, in each of the figures, (a) shows a side view, (b) shows a sectional view along the line (b)-(b) in (a), (c) shows a plan view, and(d) shows a perspective exploded view;

FIGS. 19 to 21 show different views of tube connection arrangements according to the invention for two tubes which are arranged at an angle to one another, wherein, in each of the figures, (a) shows a side view, (b) shows a plan view, and (c) shows a perspective exploded view.

### DESCRIPTION

The relative terms used in the following description, such as for example left, right, above and below, refer to the drawings and are not intended to limit the application in any way, even though they may refer to preferred arrangements. The word “substantially” in relation to dimensions such as distances, diameters, etc. is intended to encompass deviations of up to a maximum of 10%, preferably up to a maximum of 5%.

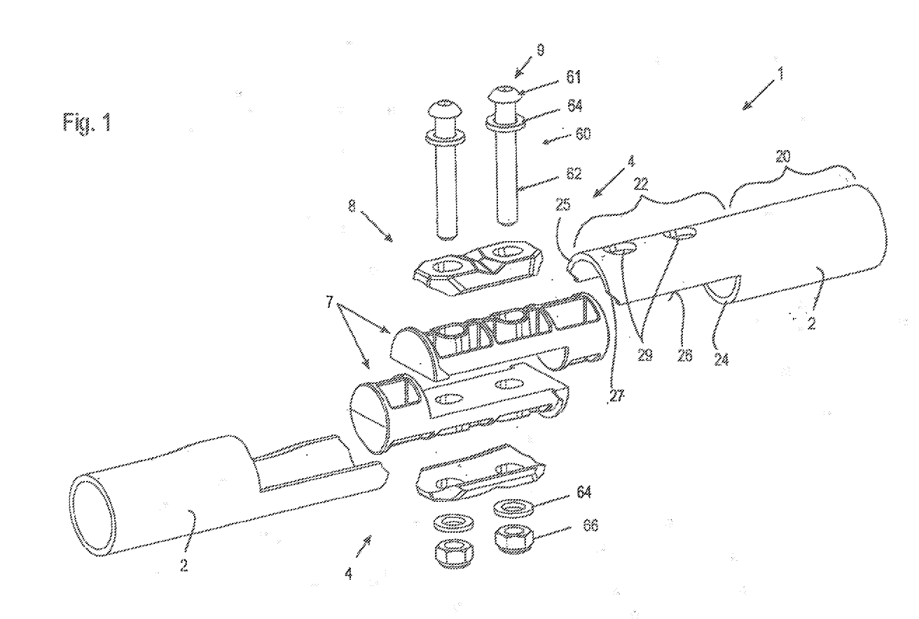

A first embodiment of a tube connection 1 for two tubes 2, 2 will be explained in greater detail hereafter with reference to FIGS. 1 to 8. The tube connection 1 consists substantially of two tube connection arrangements 4, which have the same construction. Each of the tube connection arrangements 4 is formed by one of the tubes 2 and an insert 7. Also shown in FIG. 1 are washer elements 8 and fastening units 9.

To simplify the description, just one of the tube connection arrangements 4 will be explained in greater detail below since the two are substantially identical.

The tube 2 of a tube connection arrangement 4 has a first full-tube portion 20 and, at the free (fastening) end thereof, a part-tube portion 22. The full-tube portion 20 may have a conventional tube shape, such as for example a circular shape or else an oval shape. In the illustrated tube connection, the tubes 2 and thus the full-tube portions 20 are circular in each case. The full-tube portion 20 has substantially a tube body with a full circumference in the radial direction.

The part-tube portion 22 is formed in one piece with the full-tube portion 20 and is preferably formed by providing a suitable cutout at one end of a full-tube portion 20. The cutout can be produced in a precise manner in particular by laser cutting. The cutout is preferably configured such that the part-tube portion 22 substantially forms a half-tube, that is to say that the cutout extends over half of the tube 2 in the direction of the diameter. As a half-tube, the part-tube portion 22 thus circumscribes an angle of substantially 180°, wherein substantially deviations of up to 10°, preferably up to 5°, are intended to be encompassed. Front edges 24, 25 are formed both at the end of the full-tube portion 20 (at the transition to the part-tube portion 22) and at the free end of the part-tube portion 22, which front edges, as viewed from the corresponding end of the tube, each describe substantially the shape of a half-tube. These front edges 24 25 are connected by longitudinal edges 26 which extend in the longitudinal direction of the tube 2. The front edge 25 at the free end of the part-tube portion 22 has, adjacent to each of the longitudinal edges 26, a guide bevel 27, the function of which will be explained in greater detail below.

The part-tube portion 22 further has two through-openings 29 which are arranged at the highest point of the part-tube portion (in the middle between the longitudinal edges 26 in the radial direction) and are spaced apart in the longitudinal direction of the tube 2. Although two of these through-openings 29 are shown in each of the figures, it should be noted that more or else fewer through-openings may be provided.

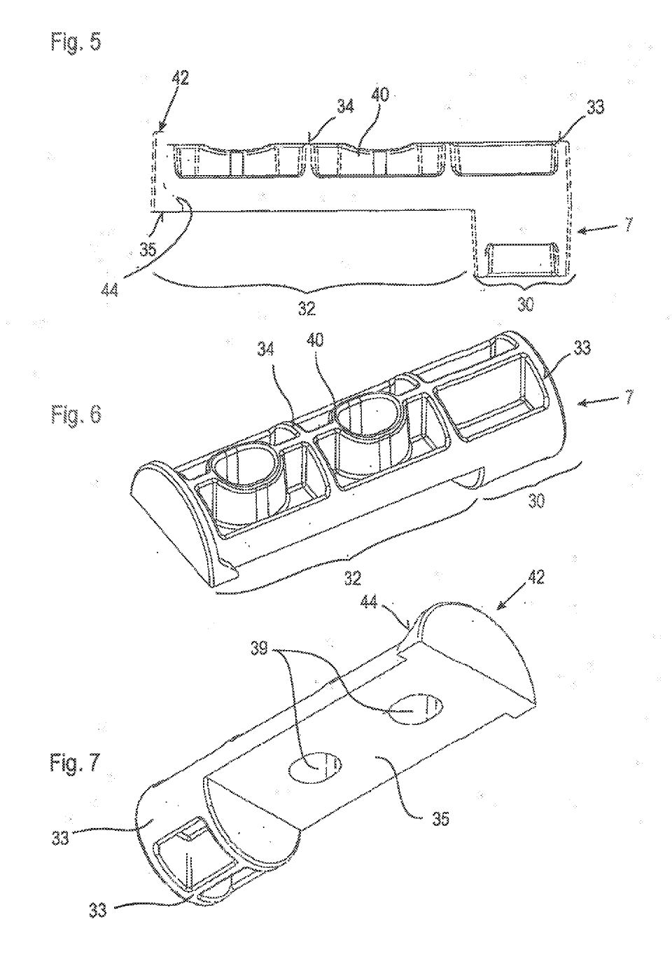

The insert 7 of such a tube connection arrangement 4 will be explained in greater detail in particular with reference to FIGS. 5 to 7, which show different views of the insert 7. The insert 7 is preferably formed as a plastic cast component, in particular as an injection-moulded or die-cast component. The insert 7 has a first portion 30 and a second portion 32.

The first portion 30 is adapted to the internal contour of the full-tube portion 20 of the tube 2 and is dimensioned such that it can be tightly received in the full-tube portion 20. In the case of a circular tube 2, as shown in the figures, the insert 7 thus has a substantially circular circumferential contour 33 in the region of the portion 30, wherein relatively large free spaces or recesses are created during manufacture, as can be seen in particular in the perspective views shown in FIGS. 6 and 7. On the whole, however, contact surfaces are provided either as a large surface area or in the form of webs which together define a circular circumferential contour 33 (or a different contour adapted to the internal contour of the tube 2).

The portion 32 of the insert 7 has a curved contour 34, adapted to the internal contour of the part-tube portion 22, and also a flat abutment side 35. Once again, the curved contour 34 may have depressions and webs created during manufacture, which provide a corresponding contour 34 at least at some points. The contour 34 is configured such that it can bear tightly against the internal contour of the part-tube portion 22 of the tube 2. When this is the case, the longitudinal edges 26 of the part-tube portion 22 and the flat abutment side 35 of the portion 32 of the insert 7 form a substantially planar abutment surface.

Provided in the flat abutment side 35 are two through-openings 39 which extend towards the curved contour and are surrounded by corresponding webs 40, as can best be seen in FIG. 6, The through-openings 39 are spaced apart in the longitudinal direction of the insert 7, namely with substantially the same spacing as the through-openings 29 in the part-tube portion 22 of the tube 2. In addition, the through-openings 39 and 29 have substantially the same circumferential dimensions and they are aligned with one another when the insert 7 is received in the tube 2, as will be described in greater detail below.

At the free end of the second portion 32, the insert 7 further has an optional guide flange 42, which protrudes beyond the contour 34 of the second portion 32. The guide flange 42 is dimensioned such that it makes contact with the front edge 25 of the part-tube portion 22 when the insert 7 is inserted in the tube 2. In the circumferential direction, the guide flange 42 is substantially flush with the outer surface of the part-tube portion 22 of the tube 2. For precise positioning of the insert in a circumferential direction, the flange 42 has guide bevels 44 corresponding to the guide bevels 27. By virtue of the guide flange 42, the insert 7 can be precisely positioned in the tube 2, wherein in particular the through-openings 29 are aligned with the corresponding through-openings 39.

Instead of providing the guide flange 42 in the region of the free end of the second portion 32 of the insert 7, it would also be conceivable to provide a corresponding guide flange in the region of the transition between the first and second portion of the insert 7. Such a flange could then make contact with the front edge 24 of the full-tube portion 20. Here, too, suitable alignment bevels or other elements could be provided in order to ensure correct positioning of the insert 7 in the longitudinal and circumferential direction of the tube 2. Instead of the guide flange 42 with its guide bevel 44 and the corresponding guide bevel 27 on the part-tube portion 22, it is also conceivable to provide other complementary guides which ensure correct positioning between the tube 2 and the insert 7. In particular, an alignment of the corresponding through-openings 29 and 39 is advantageous.

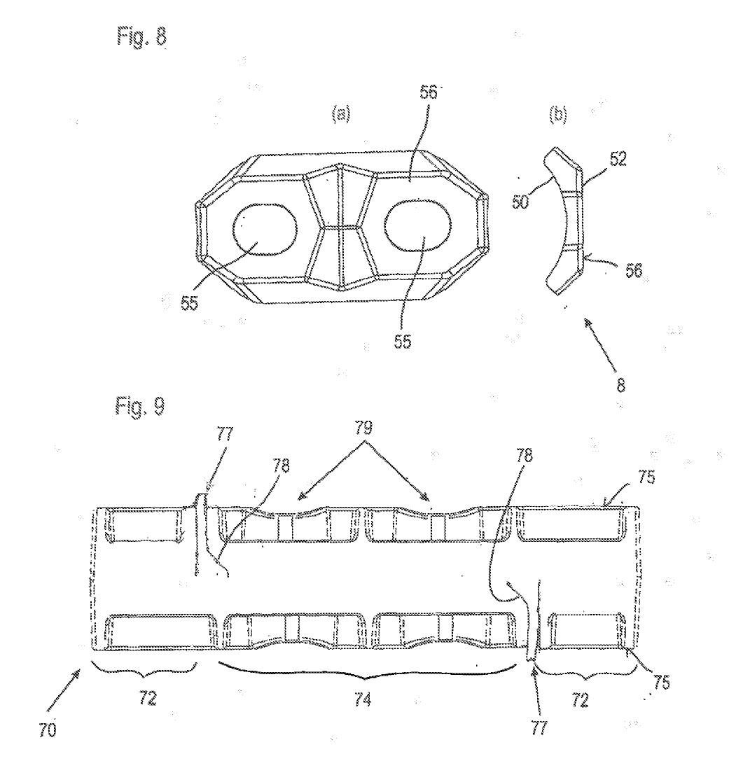

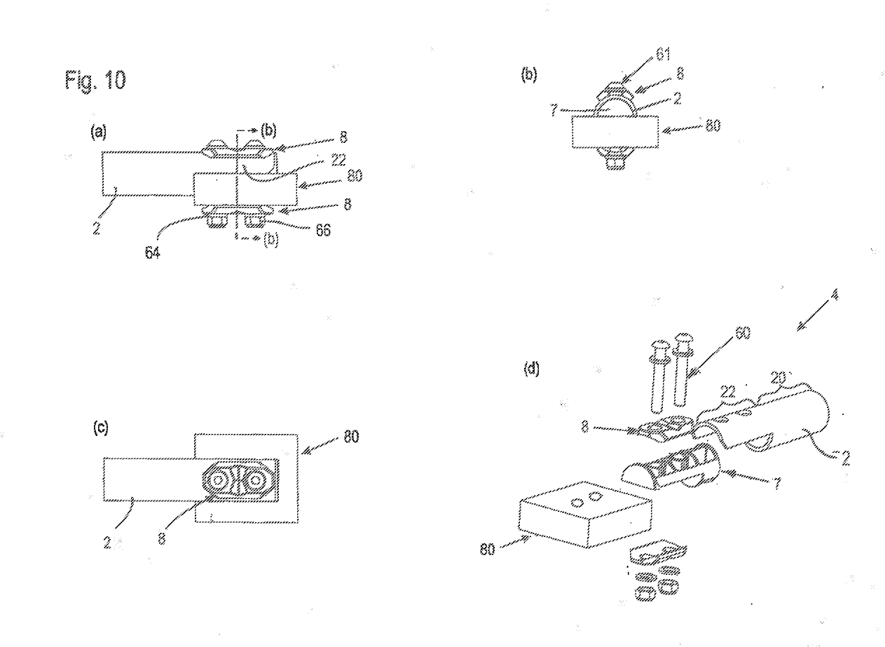

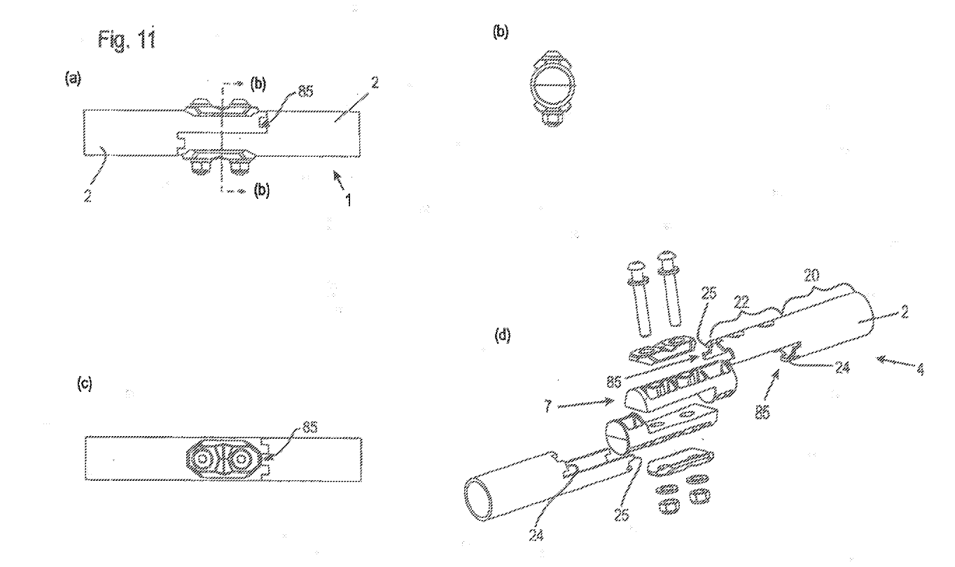

The specially shaped tube 2 with the part-tube portion 22 and the insert 7 together form a complete fastening arrangement 4 which enables the fastening of the tube 2 to a flat counter-surface (with reference to suitable fastening elements 9), as will be recognized by a person skilled in the art. As the flat counter-surface, use may be made here of a corresponding second fastening arrangement 4 for connecting two tubes to one another, as shown in FIG. 1, or else some other counter-surface 30 having a flat surface, as indicated in FIG. 10. One such other counter-surface may be for example a body component of a motorcycle or snowmobile or else some other component. As an additional, optional element, the fastening arrangement 4 shown in the figures also has a washer element 8. This washer element 8 is preferably once again formed as e plastic cast component, in particular an injection-moulded or die-cast component, and will be explained in greater detail below with reference to FIGS. 8A and B. FIG. 8 shows a plan view of the washer element, and FIG. B shows an end view. As can be seen in the end view, the washer element 8 has a curved side 50 and also an at least partially flat top 52. The curved side 50 is adapted to an external contour of the part-tube portion 22 of the tube 2. As a result, the curved side 50 can bear tightly against the part-tube portion 22.

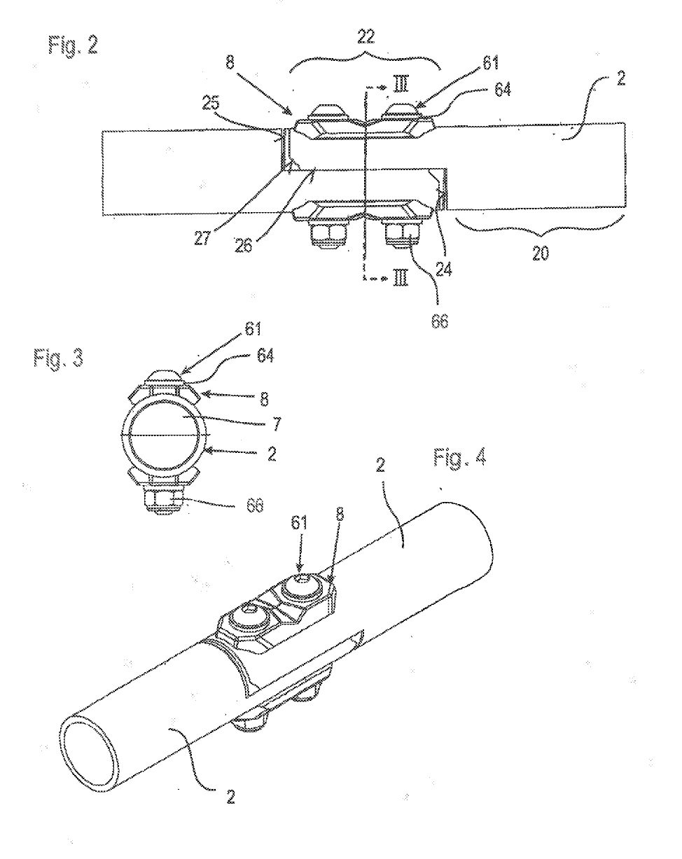

Formed in the washer element 8 are two through-openings 55 which, with regard to the circumferential shape and spacing thereof, correspond substantially to the circumferential shape and spacing of the through-openings 29 in the part-tube portion 22 (and thus the through-openings 39 in the insert 7). The flat side 52 has a flat abutment surface 56 at least surrounding the through-openings 55. In particular, the abutment surface 56 may serve as an abutment for a washer, for the head of a fastening element and/or for a nut, as can be seen for example in FIGS. 2 to 4.

The fastening units 9 shown in the figures each consist of a screw 60 having a screw head 61 and a threaded shank 62, the thread not having to extend over the entire length of the screw 60, washers 64 and a nut 68, which is preferably designed as a self-locking nut 64. However, other types of fastening units are also conceivable, such as for example rivets, splints or pins.

The establishment of a connection between the tube ends of two tubes 2 will now be explained in greater detail. The tubes 2 each have the construction described above comprising a full-tube portion 20 and a corresponding part-tube portion 22. An insert 7 of the type described above is arranged in each of the tubes 2 in such a way that the longitudinal edges 26 of the respective part-tube portions 22 and the straight sides 35 of the inserts 7 form a flat abutment surface. The part-tube portions 22 are each configured as half-tube portions. The part-tube portions 22 are arranged in an overlapping manner, as shown in FIG. 2, namely in such a way that the through-openings 29 of the respective part-tube portions 22 and the through-openings 35 in the respective inserts 7 are aligned with one another. The washer elements 8 can then be placed onto the part-tube portions 22 and the screws 60 are fed through the corresponding arrangement. The screws 60 each have such a length that they extend fully through the corresponding tubes 2 with inserts 7 and the washer elements 8 in order to enable the nuts 66 to be screwed on. Washers 64 may additionally be arranged between one washer element 8 and the screw heads 61 and/or between the other washer element 8 and the nuts 66, as shown in FIG. 2. Such an arrangement of the tubes with tube connection arrangements enables a straight connection of two tubes to one another A rotation of the tubes relative to one another is prevented by the two fastening units 9. Forces occurring between the tubes can act directly on the overlapping part-tube portions 22 via the screws and do not necessarily have to be transmitted via the insert 7, but an at least partial transfer of forces via the inserts can also take place. Nevertheless, the insert gives stability to the connection arrangement and inter alia prevents for example any spreading of the part-tube portions 22 as the screws 60 and nuts 64 are tightened. In addition, a positioning of the tubes relative to one another can be achieved via the insert 7.

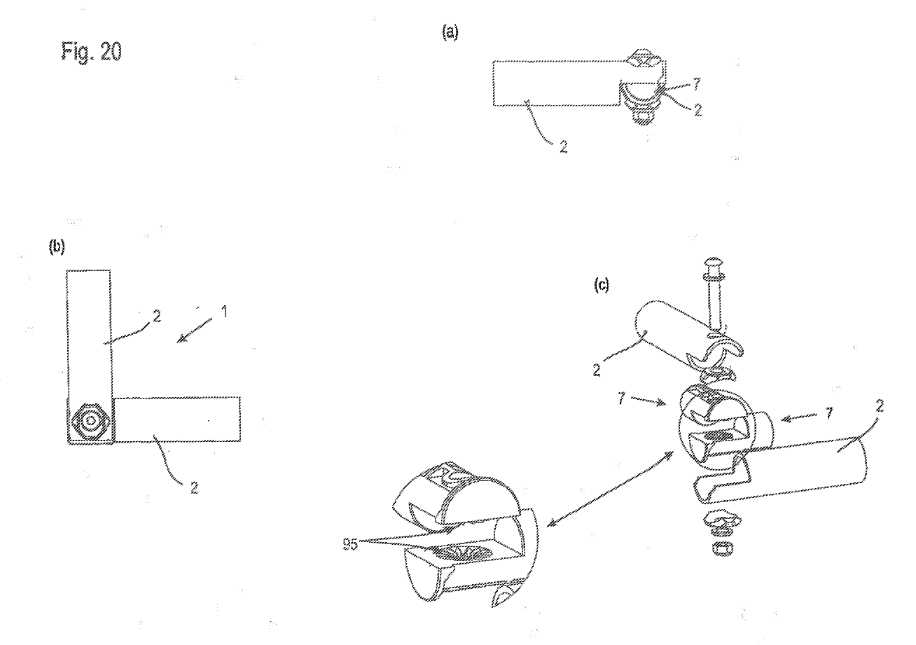

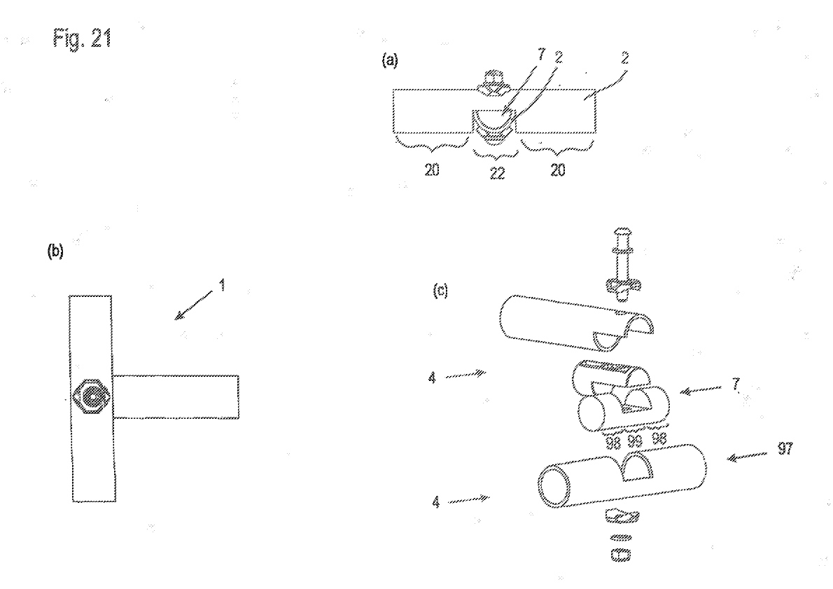

If two tubes 2 are to be connected to one another at an angle, substantially the same tube connection arrangement can be used, wherein then use is made for example of just one fastening unit (for example consisting of screw 60 and nut 64). Alternatively, it is also possible that, for such tube connections, the respective elements part-tubs portion 22, insert 7 and washer element 8 have just one through-opening. Such a configuration is shown for example in FIGS. 20 and 21, which will be discussed in greater detail below.

Besides a connection to a corresponding further tube connection arrangement a connection arrangement 4 consisting of tube 2, insert 7 and optional washer element 8 can also be used for connection to another flat surface (see for example FIG. 10), such as for example a fastening flange on a motorcycle or snowmobile. To this end, the part-tube portion 22 with insert 7 is suitably arranged in a manner overlapping the corresponding fastening surface and is fastened by way of a suitable fastening element. In this case, it is also possible for example that a screw is screwed directly into a corresponding fastening flange, that is to say does not extend through the fastening flange but rather only into the latter.

Instead of the screws shown here, it is also possible to provide, for fastening purposes, rivets or other suitable fastening elements having a shank element which extends through or into the elements to be connected.

FIG. 9 shows an alternative embodiment of an insert 70 which can be used instead of the inserts 7 to connect two tubes 2 of the type described above. The insert 70 may once again be formed as a plastic cast component, in particular as an injection-moulded or die-cast component.

The insert 70 has end portions 72 at its opposite ends and also a middle portion 74 located therebetween. The and portions 72 and the middle portion each have an external contour 75 adapted to the internal circumference of the full-tube portions of the tubes 2. Provided between each of the end portions 72 and the middle portion is a guide flange 77 which protrudes beyond the substantially uniform external contour. The guide flanges each extend around only 180° in the circumferential direction of the insert 70 and they are offset relative to one another by 180° in the circumferential direction of the insert 70. On their side directed towards the middle portion 74, the flanges 77 each have an abutment surface which has a bevel 78 at each of its ends (in the circumferential direction of the insert 70). The flanges thus have substantially the same shape as the flanges 42 at the ends of the inserts 7. Furthermore, the insert 70 has two through-openings 79 which in the diagram shown in FIG. 9 extend through the insert 70 from top to bottom. The through-openings 79 are spaced apart in the longitudinal direction of the insert 70, namely with substantially the same spacing as the through-openings 29 in the part-tube portion 22 of the tubes 2. In addition, the through-openings 79 and 29 have substantially the same circumferential dimensions and they are aligned with one another when the insert 70 is received in the tubes 2, as will be described in greater detail below. The insert 70 thus substantially has the form of two inserts 7 connected at the straight sides 35, but is formed in one piece.

Such an insert 70 can be inserted with its end portions 72 into the full-tube portions 20 of corresponding tubes 2 in such a way that the part-tube portions overlap in the region of the middle portion 74 and the respective through-openings 79 and 29 are aligned. Such an alignment can be achieved via the flanges 77, which come into engagement with front edges 25 of the part-tube portions 22. Such a connection can then be completed by way of suitable fastening units 9.

Also in such an arrangement, forces can be transmitted directly between the tubes 2 via the fastening units 9. The insert 70 once again serves inter alia to position the tubes 2 relative to one another and to prevent or at least to limit any spreading of the part-tube portions 22 during the tightening of the fastening units.

FIGS. 11 to 18 show further embodiments of tube connections, wherein the figures each show different views of the respective embodiments, wherein each of the views (a) show a side view, (b) show a sectional view along the line (b)-(b) in (a), (c) show a plan view, and (d) show a perspective exploded view. The embodiments are substantially identical to those described above, and therefore on the one hand the same reference signs will be used and on the other hand only the differences will be discussed.

In the embodiment shown in FIG. 11, a tube connection 1 for the connection of two tubes 2 has corresponding tube connection arrangements 4. The tube connection arrangements 4 each have the same construction as those first described. However, the tubes 2 each have a tooth structure 85 on the front edges 24, 25 of the full-tube portion 20 and of the part-tube portion 22, wherein the tooth structures 85 of the tubes 2 are designed to be complementary to one another. The tooth structures 85 are formed by rectangular teeth, but they could also have a different shape. The tooth structures 85 enable a secure positioning of the tubes 2 relative to one another in the circumferential direction and prevent any rotation of the tubes 2 relative to one another and enable a good transmission of rotational forces between the respective tubes 2.

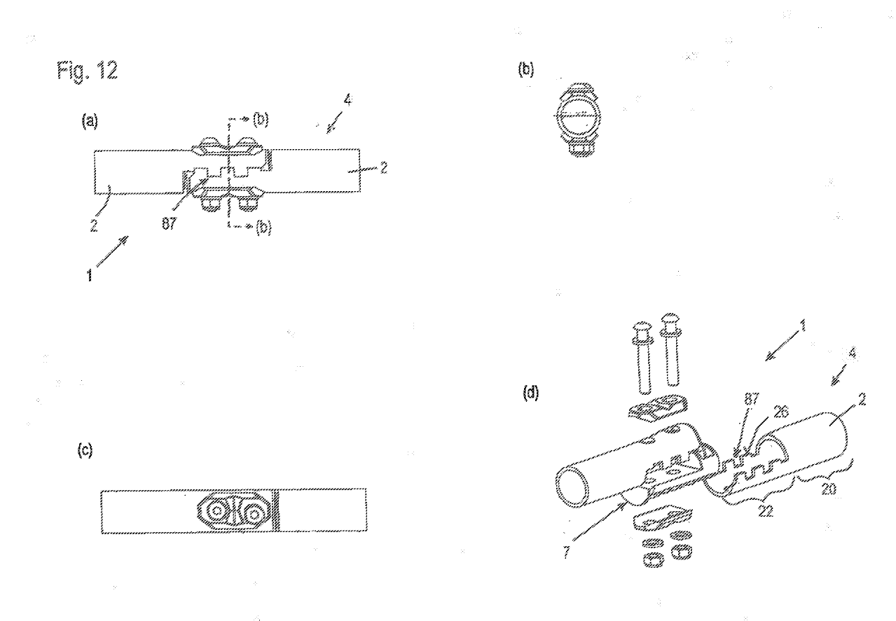

The embodiment shown in FIG. 12 also has a tube connection 1 for the connection of two tubes 2 with tube connection arrangements 4. The tube connection arrangements 4 each have substantially the same construction as those first described. However, the tubes 2 each have a tooth structure 37 on the longitudinal edges of the part-tube portion 22 connecting the front edges 24, 25, wherein the tooth structures 87 of the tubes 2 are designed to be complementary to one another. The tooth structures 87 are formed by rectangular teeth, but they could also have a different shape. The tooth structures 87 enable a secure positioning of the tubes 2 relative to one another in the longitudinal direction. They also enable a good transmission of tensile forces acting in the longitudinal direction (axially) between the respective tubes 2.

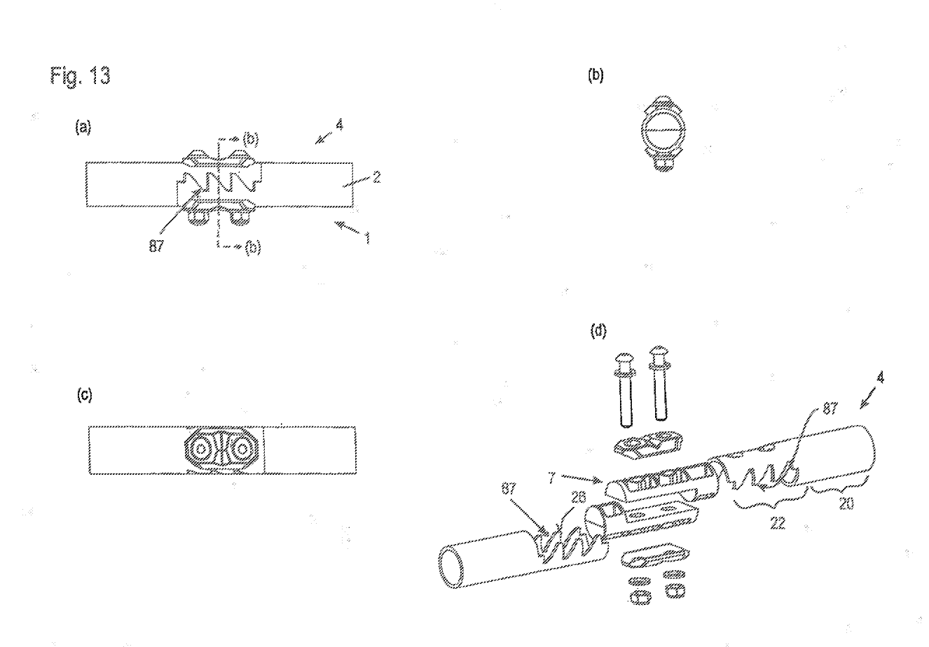

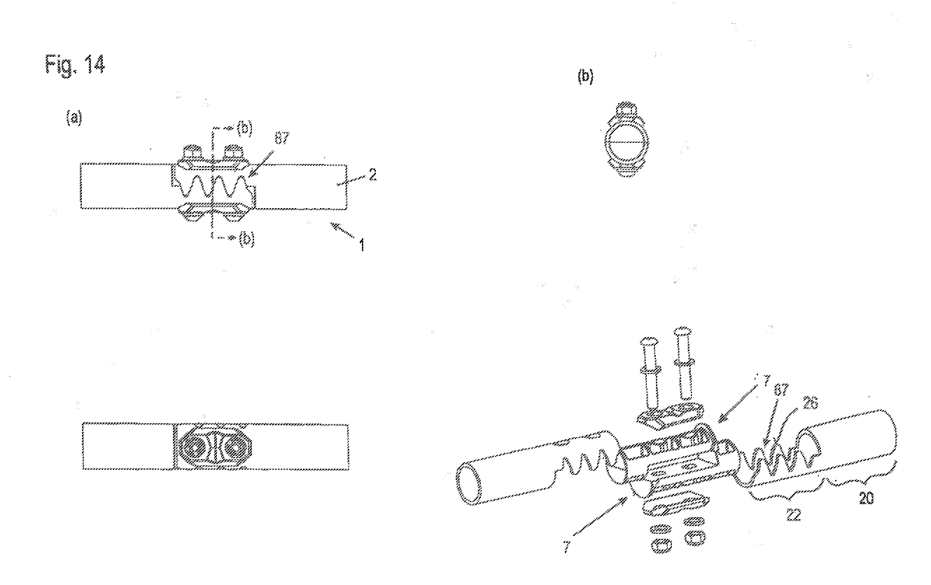

The embodiments shown in FIGS. 13 and 14 are substantially identical to the embodiment shown in FIG. 12, but the respective tooth structures 37 have a different shape. For instance, a saw-tooth configuration is provided in the embodiment shown in FIG. 13, while a wave configuration is provided in the embodiment shown in FIG. 14. Besides the advantages mentioned above, the saw-tooth configuration can additionally give rise to an axial biasing of the elements with respect to one another. The wave configuration can likewise achieve an axial bias and is particularly suitable for compensating tolerances between the elements.

As a person skilled in the art can see, tooth structures 85 and 87 can also be combined, and use can also be made of an insert 70 according to FIG. 9.

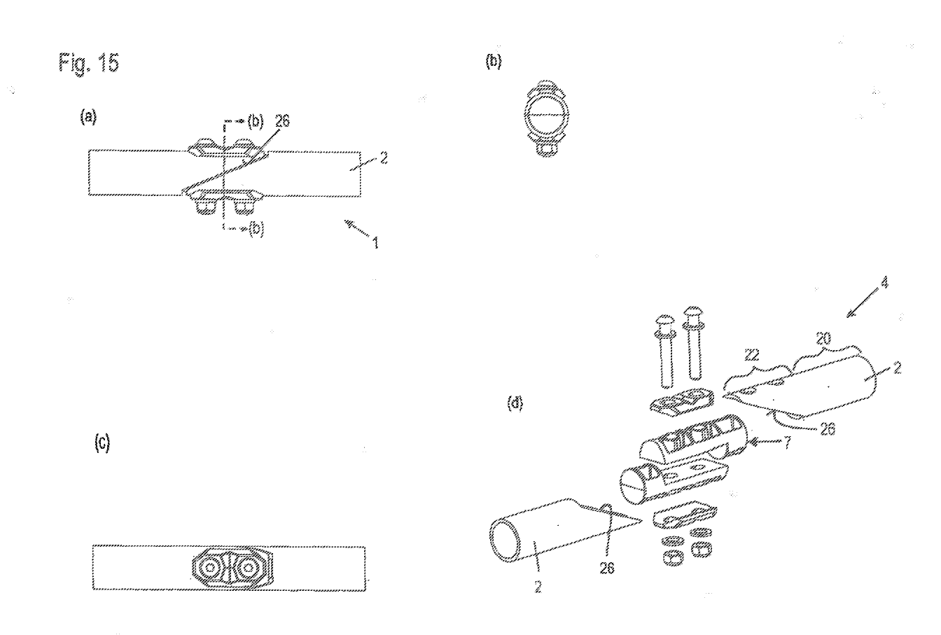

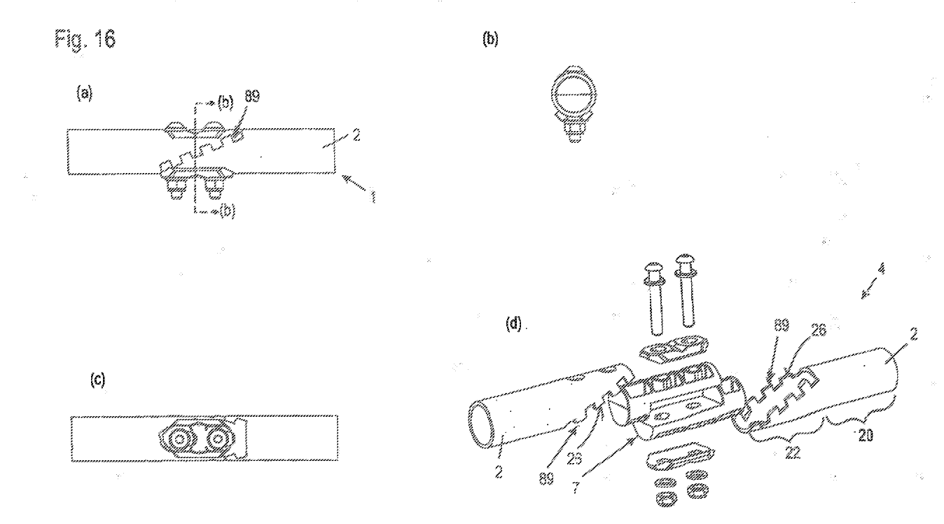

In the embodiment shown in FIG. 15, a tube connection 1 for the connection of two tubes 2 again has tube connection arrangements 4. The tube connection arrangements 4 each have substantially the same construction as those first described. However, the tubes 2 each have sloping longitudinal edges 26 in the region of the part-tube portion 22, so that the part-tube portions 26 taper towards their free end. The embodiment shown in FIG. 16 is similar to that shown in FIG. 15, but a tooth structure 89 is provided on each of the sloping edges 26. The tooth structures 89 of the two tubes are again complementary to one another. An insert 70 can also be used in this configuration.

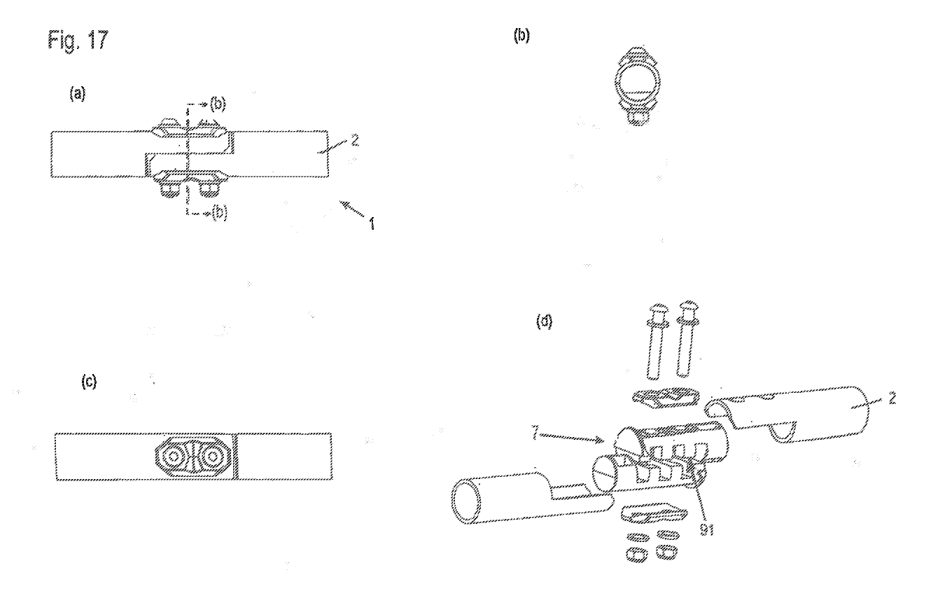

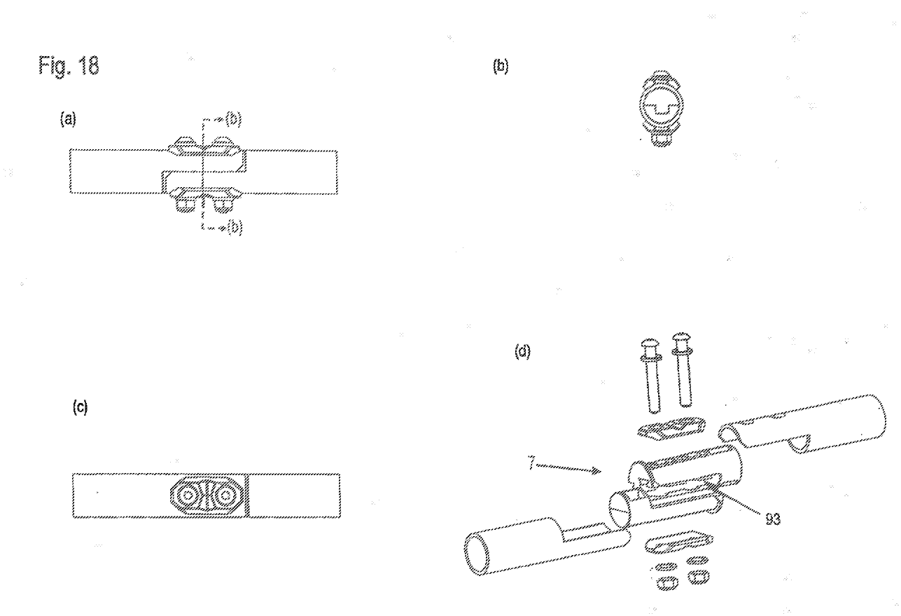

The embodiments shown in FIG. 17 and FIG. 18 each have, once again, a tube connection 1 for the connection of two tubes 2 with tube connection arrangements 4. The tube connection arrangements 4 each have substantially the same construction as those first described. However, the inserts 7 are configured in such a way that the abutment surfaces thereof are not flat but rather are structured in such a way that they have tooth structures 91 and 93 which are complementary to one another. In the embodiment shown in FIG. 17, the tooth structures 91 are formed by rectangular grooves extending transversely to the longitudinal direction. The teeth formed therebetween have such a length that the teeth of one insert 7—when two inserts 7 are joined—engage in the grooves of the other insert. In the embodiment shown in FIG. 18, the tooth structures 93 are formed by a longitudinal groove with local widening potions on one insert 7 and a complementary protrusion on the other insert 7.

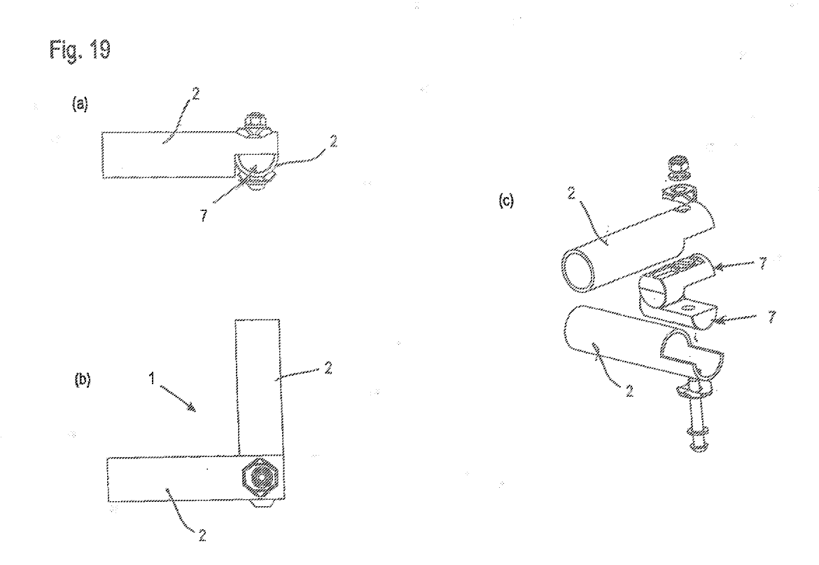

FIGS. 19 to 21 show further embodiments for tube connections for two tubes. In these embodiments, however, the tubes are arranged at an angle to one another. In each of the figures, (a) shows a side view, (b) shows a plan view, and (c) shows a perspective exploded view.

In the embodiment shown in FIG. 19, a tube connection 1 for the connection of two tubes 2 has tube connection arrangements 4. The tube connection arrangements 4 each have substantially the same construction as those first described. However, the tubes 2 have just one through-opening in the part-tube portions 22. Correspondingly, the inserts 7 also each have just one through-opening. As can be seen by a person skilled in the art, two tubes 2 with correspondingly inserted inserts 7 can now be arranged at an angle to one another and fastened to one another (as long as the part-tube portions 22 have a sufficient length to permit such an angular arrangement). For a substantially perpendicular arrangement of the tubes 2 relative to one another, part-tube portions 22 of the tubes could be dimensioned such that an alignment of the respective through-openings is possible only at right angles to one another in the embodiment shown in FIG. 20, the inserts 7 have a tooth structure 95 in the region of the abutment surfaces around the through-opening. Said tooth structure is formed by depressions on one of the inserts 7 and by complementary protrusions on the other insert 7. These are arranged in a circle in such a way that they define particular angle settings of the inserts 7 relative to one another. For example, the depressions and the protrusions may be designed in such a way that meshing is possible in each case upon rotation through 5°. Of course, a different tooth is also possible. Such a tooth can define and maintain the angle setting between the tubes 2 relative to one another.

in the embodiment shown in FIG. 21, a tube connection 1 for the connection of two tubes 2 has tube connection arrangements 4. One of the tube connection arrangements 4 has substantially the same construction as a tube connection arrangement 4 shown in FIG. 19 or 20. However, the other tube connection arrangement 4 has a different construction consisting of tube 2 and insert 97. Here, the tube 2 has such a cutout that a part-tube portion 22 is formed between two full-tube portions 20. The part-tube portion 22 has a length which corresponds at least to an external diameter of the other tube 2.

The insert 97 has end portions 98 and also a middle portion 99 located between the end portions. The end portions are each adapted to the internal contour of the full-tube portions 20 of the tube 2 and are dimensioned such that they can be tightly received in the full-tube portions 20. In the case of a circular tube 2, as shown in the figures, the insert 97 thus has a substantially circular circumferential contour in the region of the end portions 98, wherein once again relatively large free spaces or recesses may be created during manufacture. The middle portion 99 of the insert 7 has a curved contour adapted to the internal contour of the part-tube portion 22, and also a flat abutment side. The length of the middle portions substantially corresponds to the length of the cutout in the tube 2.

As can be seen, such an arrangement enables a connection of one tube to another tube along any point of the tube and not just at the ends. Of course, it would also be possible that both connection arrangements 4 have a part-tube portion 22 between two full-tube portions 20 and an insert 97, in order in this way to connect two intersecting tubes 2 to one another. The insert could once again have a tooth structure 95 as shown in FIG. 20 in order to enable an angled arrangement of the tubes 2 relative to one another.

in FIGS. 10 to 21, use can be made of the same washer elements 8 and fastening units as in the first embodiment, it possibly being necessary to adapt the dimensions of the washer elements and the number of through-openings.

The invention has been explained in detail with reference to specific embodiments and the figures, without being limited to the specific embodiments. In particular, the different embodiments can be combined with one another in so far as they are compatible. The shape of the inserts can also be selected differently, and it is possible that corresponding tube connection arrangements are provided at both ends and/or at different positions along a tube.

1. A tube connection arrangement (4), which comprises the following:
a tube (2) having at least one cutout which is configured such that a part-tube portion (22) adjoins a full-tube portion (20) of the tube (2), wherein at least one through-opening (29) is formed in the part-tube portion (22); and
an insert (7) having a first portion (30) which is suitable for being received in the full-tube portion (20) of the tube (2) and which has an external contour (33) adapted to the internal circumference of the full-tube portion (20), and a second portion (32) which is suitable for being received in the part-tube portion (22) of the tube (2) and which has a curved contour (34), adapted to the internal contour of the part-tube portion (22), and an opposite abutment side (35), wherein at least one through-opening (39) is formed in the second portion (32), and wherein, in the inserted state of the insert (7), the abutment side (35) of the second portion is directed towards the cutout of the part-tube portion (22) and the through-openings (23, 39) in the part-tube portion (22) and in the second portion (32) of the insert (7) are aligned in order to enable a fastening element to be fed therethrough.

2. The tube connection arrangement (4) according to claim 1, wherein the insert (7) has, at a free end of the second portion (32) and/or at the end of the first portion (30) located adjacent to the second portion (32), an abutment flange (42) for abutment against a front edge (25) of the part-tube portion (22).

3. The tube connection arrangement (4) according to claim 2, wherein the abutment flange (42) and the front edge (25) have at least one complementary alignment contour (27, 44).

4. The tube connection arrangement (4) according to claim 1, wherein at least two through-openings (29, 39) are provided in the part-tube portion (22) and in the second portion of the insert (7).

5. The tube connection arrangement (4) according to claim 1, wherein the insert (7) is a plastic cast component, in particular an injection-moulded or die-cast component.

6. The tube connection arrangement (4) according to claim 1, further comprising at least one washer component (8) which has a first side (50), adapted to the external contour of the part-tube portion (22), and an opposite second side (52), wherein the washer component (8) has at least one through-opening (55) for a fastening element, and wherein the second side (52) has in the region of the through-opening (55) a flat abutment surface (56) for a abutment surface of a fastening element.

7. The tube connection arrangement (4) according to claim 1, wherein the cutout tor forming the part-tube portion (22) is formed at the end of the tube (2) in such a way that the part-tube portion (22) protrudes beyond the full-tube portion (20).

8. The tube connection arrangement (4) according to claim 7, wherein a front end of the full-tube portion (20) and/or of the part-tube portion (22) has a tooth structure.

9. The tube connection arrangement (4) according to claim 7, wherein at least one radially directed longitudinal edge of the part-tube portion (22) has a tooth structure.

10. The tube connection arrangement (4) according to claim 8, wherein at least one of the tooth structures describes one of the following shapes; saw-tooth, rectangle, triangle and wave.

11. The tube connection arrangement (4) according to claim 1, wherein the cutout for forming the part-tube portion (22) is located between two full-tube portions (20), wherein the insert (7) has a third portion which is suitable tor being received in the full-tube portion (20) of the tube (2) and which has an external contour (33) adapted to the internal circumference of the full-tube portion (20), and wherein the second portion of the insert (7) is located between the first and the third portion.

12. The tubs connection arrangement (4) according to claim 1, wherein the abutment side (35) of the insert (7) is flat.

13. The tube connection arrangement (4) according to claim 1, wherein the abutment side (35) of the insert (7) has a tooth structure.

14. The tube connection arrangement (4) according to claim 1, wherein the part-tube portion (22) is substantially a half-tube portion.

15. A tube connection (1) of two tubes (2), which has for each tube (2) a tube connection arrangement (4) according to claim 1, wherein the part-tube portions (22) of the tubes (2) with inserted inserts (7) are arranged in an overlapping manner in such a way that the abutment sides (35) of the second portions (32) of the inserts (7) make contact with one another, and wherein at least one fastening element (60) is provided which extends through the through-openings (29, 39) in the two part-tube portions (22) and in the inserts (7) in order to fasten the tubes (2) to one another.

16. The tube connection (1) according to claim 15, wherein the tube connection arrangements (4) for each of the tubes (2) each have a tooth structure, wherein the tooth structures of the tube connection arrangements (4) are complementary to one another.

17. The tube connection (1) according to claim 15, wherein the tooth structure is in each case formed in at least one of the following: a front end of the full-tube portion (20), a front end of the part-tube portion (22), a radially directed longitudinal edge of the part-tube portion (22) and the abutment side (35) of the insert (7).

18. A tube connection arrangement (4) for two tubes (2), which has for each of the tubes, on at least one fastening end, a cutout which is configured such that, adjoining a full-tube portion (20) of the respective tube (2), a part-tube portion (22) is formed which can be arranged in a manner overlapping the part-tube portion of the other tube, wherein at least one through-opening (29) is formed in each part-tube portion (22), and
an insert (70) having an external circumference adapted to the internal circumference of the full-tube portions (22) and a length which is selected such that the insert (70) is longer than the length of a respective part-tube portion (22), so that the opposite ends of the insert (70) can be received in the full-tube portions (20) of the two tubes (2) when the part-tube portions (22) of the tubes (2) are arranged in an overlapping manner, wherein the insert (70) has at least one through-opening (79) which can be aligned with the through-openings (29) in the part-tube portions (22) when the opposite ends of the insert (70) are received in the full-tube portions (22) of the tubes (2), in order to enable a fastening element (60) to be fed through the part-tube portions (22) and the insert (70).

18. The tube connection arrangement (4) according to claim 18, wherein the insert (70) has, between its opposite ends, at least one abutment flange (77) for abutment against a front edge (25) of a part-tube portion (22).

20. The tube connection arrangement (4) according to claim 19, wherein the abutment flange (77) and the front edge (25) have at least one complementary alignment contour (27, 78).
